(19) United States
(12) Patent Application Publication
(10) Pub. No.: US 2016/0174021 A1
(43) Pub. Date: Jun. 16, 2016

(54) ELECTRONIC DEVICE FOR REQUESTING OR PERFORMING SCAN THROUGH SHORT RANGE COMMUNICATION AND OPERATION METHOD THEREOF

(71) Applicant: Samsung Electronics Co., Ltd., Gyeonggi-do (KR)

(72) Inventors: Tae-Hun LIM, Gyeonggi-do (KR); Hyuk KANG, Gyeonggi-do (KR); Gi-Beom KIM, Gyeonggi-do (KR); Jin-Hyun PARK, Gyeonggi-do (KR); Chun-Ho PARK, Seoul (KR); Jun-Hak LIM, Gyeonggi-do (KR)

(73) Assignee: Samsung Electronics Co., Ltd.

(21) Appl. No.: 14/971,571

(22) Filed: Dec. 16, 2015

(30) Foreign Application Priority Data
Dec. 16, 2014 (KR) 10-2014-0181802

(51) Int. Cl. H04W 4/00; H04W 76/02; H04W 8/00

(52) U.S. Cl. CPC H04W 4/008; H04W 8/005; H04W 76/023

(57) ABSTRACT

A method of an electronic device for making a request for a scan via short range communication and the electronic device is provided. The method includes periodically broadcasting a scan request for one or more short range communication devices; and receiving a scan result of a scan device for the one or more short range communication devices from the scan device in response to the scan request. The electronic device includes a communication module configured to broadcast a scan request for one or more short range communication devices and receive a scan result of a scan device for the one or more short range communication devices from the scan device in response to the scan request; and a processor configured to control the communication module to periodically broadcast the scan request.

### PRIORITY

This application claims priority under 35 U.S.C. §119(a) to a Korean Patent Application filed on Dec. 16, 2014 in the Korean Intellectual Property Office and assigned Serial No. 10-2014-0181802, the entire contents of which are incorporated herein by reference.

### BACKGROUND

1. Field of the Invention

The present invention relates generally to an electronic device for requesting or performing a scan via short range communication and a method thereof.

2. Description of the Related Art

Currently, various devices (for example, tablet Personal Computers (PCs), wearable devices, smart phones, earphones and the like) support short range communication (for example, Bluetooth (BT), Wireless Fidelity (WiFi) and the like). Devices supporting short range communication perform an operation of continuously scanning for devices which meet a condition for accessing short range communication. Devices that support short range communication via a scan for devices for a short range communication connection may be connected with devices which meet the condition via short range communication.

Further, devices supporting short range communication may receive beacon signals from beacons and display information related to areas where the beacons are installed. A beacon may be a device which transmits/receives a beacon signal at a predetermined time interval based on various communication schemes (for example, Bluetooth, WiFi, ANT and the like). Devices supporting short range communication may perform a scan to receive a beacon signal and then receive the beacon signal from the beacon.

In order to perform short range communication, an electronic device supporting short range communication continuously scans for adjacent short range communication devices to which the electronic device can be connected via short range communication. Further, the electronic device continuously scans for beacons transmitting beacon signals to receive the beacon signals. However, the scan causes power consumption, and thus an electronic device sensitive to power consumption has difficulty in continuously performing the scan.

### SUMMARY

The present invention has been made to address the above described problems and disadvantages, and to provide at least the advantages described below. Accordingly, an aspect of the present invention provides an electronic device for requesting or performing a scan via short range communication and a method thereof.

In accordance with an aspect of the present invention, a method of an electronic device making a request for a scan via short range communication is provided. The method includes periodically broadcasting a scan request for one or more short range communication devices; and receiving a scan result of a scan device for the one or more short range communication devices from the scan device in response to the scan request.

In accordance with another aspect of the present invention, an electronic device for making a request for a scan via short range communication is provided. The electronic device includes a communication module configured to broadcast a scan request for one or more short range communication devices and receive a scan result of a scan device for the one or more short range communication devices from the scan device in response to the scan request; and a processor configured to control the communication module to periodically broadcast the scan request.

In accordance with another aspect of the present invention, a method of an electronic device for performing a scan via short range communication is provided. The method includes receiving a scan request for one or more short range communication devices periodically broadcast from a scan request device; and transmitting a scan result for the one or more short range communication devices to the scan request device in response to the scan request.

In accordance with another aspect of the present invention, an electronic device for performing a scan via short range communication is provided. The electronic device includes a communication module configured to receive a scan request for one or more short range communication devices periodically broadcast from a scan request device and transmit a scan result for the one or more short range communication devices to the scan request device in response to the scan request; and a processor configured to control the communication module to transmit a scan result for the one or more short range communication devices to the scan request device in response to the scan request.

In accordance with another aspect of the present invention, a method of an electronic device for making a request for a scan via short range communication is provided. The method includes periodically broadcasting an advertisement signal including a scan request for one or more short range communication devices; and receiving a pairing request including a scan result corresponding to the scan request from a scan device in response to the scan request.

According to various embodiments of the present disclosure, an electronic device has enough power may perform a scan on behalf of an electronic device sensitive to power consumption and transmit a scan result to the electronic device sensitive to power consumption. Accordingly, the electronic device sensitive power consumption can reduce power consumption generated due to the scan. Further, the electronic device sensitive to power consumption can connect short range communication or receive a beacon signal based on the received scan result.

### BRIEF DESCRIPTION OF THE DRAWINGS

The above and other aspects, features, and advantages of the present invention will be more apparent from the following detailed description, taken in conjunction with the accompanying drawings, in which:

FIG. 1 is a block diagram of a network environment including an electronic device according to an embodiment of the present invention;

FIG. 2 illustrates a method of an electronic device according to an embodiment of the present invention;

FIG. 3 is a block diagram of a scan request module of an electronic device according to an embodiment of the present invention;

FIG. 4 is a block diagram of a scan device according to an embodiment of the present invention;

FIG. 5 is a flowchart of a short range communication connection method of an electronic device according to an embodiment of the present invention;

FIG. 6 is a flowchart of a method of an electronic device according to an embodiment of the present invention;

FIG. 7 is a flowchart of a method of a scan device according to an embodiment of the present invention;

FIG. 8 is a flowchart of a method in which an electronic device receives a service according to an embodiment of the present invention;

FIG. 9 is a flowchart of a method of an electronic device according to an embodiment of the present invention;

FIG. 10A is a flowchart of a method of an electronic device according to an embodiment of the present invention;

FIG. 10B illustrates a screen in which an application is executed by an electronic device according to an embodiment of the present invention;

FIG. 11 is a flowchart of a method in which an electronic device receives a service according to an embodiment of the present invention;

FIG. 12 is a flowchart of a method of an electronic device according to an embodiment of the present invention;

FIG. 13 is a flowchart of a method of a scan device according to an embodiment of the present invention;

FIG. 14 illustrates an electronic device displaying a received service according to an embodiment of the present invention;

FIG. 15 illustrates a scan request packet of an electronic device according to an embodiment of the present invention;

FIG. 16 is a table showing scan conditions according to an embodiment of the present invention;

FIG. 17 is a flowchart of a method of an electronic device according to an embodiment of the present invention; and

FIG. 18 is a block diagram of an electronic device according to an embodiment of the present invention.

### DETAILED DESCRIPTION OF EMBODIMENTS OF THE PRESENT INVENTION

Hereinafter, various embodiments of the present invention are described with reference to the accompanying drawings. However, it should be understood that there is no intent to limit the present invention to particular forms, and the present invention should be construed to cover all modifications, equivalents, and/or alternatives falling within the scope and spirit of the present invention. In describing the drawings, similar reference numerals may be used to designate similar elements.

As used herein, the expressions “have,” “may have,” “include,” or “may include” refer to the existence of a corresponding feature (e.g., numeral, function, operation, or element such as a component), and does not exclude one or more additional features.

In the present invention, the expressions “A or B,” “at least one of A or/and B,” or “one or more of A or/and B” may include all possible combinations of the items listed. For example, the expression “A or B,” “at least one of A and B,” or “at least one of A or B” refers to all of (1) including at least one A, (2) including at least one B, or (3) including both of at least one A and at least one B.

The expression “a first,” “a second,” “the first,” or “the second,” used in various embodiments of the present invention may modify various components regardless of the order and/or the importance but does not limit the corresponding components. The expressions may be used to distinguish a component element from another component element. For example, a first user device and a second user device may indicate different user devices regardless of the sequence or importance thereof. For example, a first element may be referred to as a second element, and similarly, a second element may be referred to as a first element without departing from the scope of the present invention.

When it is mentioned that one element (e.g., a first element) is “(operatively or communicatively) coupled with/to or connected to” another element (e.g., a second element), it should be construed that the one element is directly connected to the another element or the one element is indirectly connected to the another element via yet another element (e.g., a third element). Conversely, when one component element is “directly coupled” or “directly connected” to another component element, it may be construed that a third component element does not exist between the first component element and the second component element.

The expression “configured to” used in the present invention may be exchanged with, for example, “suitable for,” “having the capacity to,” “designed to,” “adapted to,” “made to,” or “capable of” according to the situation. The expression “configured to” may not necessarily imply “specifically designed to” in hardware. Alternatively, in some situations, the expression “device configured to” may indicate that the device, together with other devices or components, “is able to.” For example, the phrase “processor adapted (or configured) to perform A, B, and C” may refer to a dedicated processor (e.g. an embedded processor) only for performing the corresponding operations or a general-purpose processor (e.g., a Central Processing Unit (CPU) or Application processor (AP)) that can perform the corresponding operations by executing one or more software programs stored in a memory device.

The terms used in the present invention are only used to describe embodiments of the present invention, and are not intended to limit the present invention. As used herein, the singular forms may include the plural forms as well, unless the context clearly indicates otherwise. Unless defined otherwise, all terms used herein, including technical and scientific terms, have the same meaning as those commonly understood by a person skilled in the art to which the present invention pertains. Such terms as those defined in a generally used dictionary are to be interpreted to have the meanings equal to the contextual meanings in the related art, and are not to be interpreted to have ideal or excessively formal meanings unless clearly defined in the present invention. In some cases, even the term defined in the present invention should not be interpreted to exclude embodiments of the present invention.

For example, an electronic device may include at least one of a smartphone, a tablet Personal Computer (PC), a mobile phone, a video phone, an electronic book (e-book) reader, a desktop PC, a laptop PC, a netbook computer, a Personal Digital Assistant (PDA), a Portable Multimedia Player (PMP), a Motion Picture Experts Group Audio Layer 3 (MP3) player, a mobile medical appliance, a camera, and a wearable device (e.g., a Head-Mounted-Device (HMD) such as electronic glasses, electronic clothes, an electronic bracelet, an electronic necklace, an electronic appcessory, electronic tattoos, or a smart watch).

According to an embodiment of the present invention, an electronic device may be a smart home appliance. A home appliance may include at least one of, for example, a television, a Digital Video Disk (DVD) player, an audio player, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to an embodiment of the present invention, the electronic device may include at least one of various medical devices (e.g., various portable medical measuring devices (e.g., a blood glucose monitoring device, a heart rate monitoring device, a blood pressure measuring device, a body temperature measuring device, etc.), a Magnetic Resonance Angiography (MRA) machine, a Magnetic Resonance Imaging (MRI) machine, a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Device, an electronic device for a ship (e.g., a navigation device for a ship, and a gyro-compass), avionics devices, security devices, an automotive head unit, a robot for home or industry, an Automatic Teller Machine (ATM), Point Of Sale (POS) device in a shop, or Internet of Things (IoT) device (e.g., a light bulb, various sensors, electric or gas meter, a sprinkler device, a fire alarm, a thermostat, a streetlamp, a toaster, sporting goods, a hot water tank, a heater, a boiler, etc.).

According to an embodiment of the present invention, an electronic device may include at least one of a part of furniture or a building/structure, an electronic board, an electronic signature receiving device, a projector, and various types of measuring instruments (e.g., a water meter, an electric meter, a gas meter, and a radio wave meter). An electronic device according to an embodiment of the present invention may be a combination of one or more of the aforementioned various devices. An electronic device according to an embodiment of the present invention may be a flexible device. Further, an electronic device according to an embodiment of the present invention is not limited to the aforementioned devices, but may include a newly developed electronic device.

Hereinafter, an electronic device according to an embodiment of the present invention is described with reference to the accompanying drawings. In the present invention, the term “user” may indicate a person using an electronic device or a device (e.g. an artificial intelligence electronic device) using an electronic device.

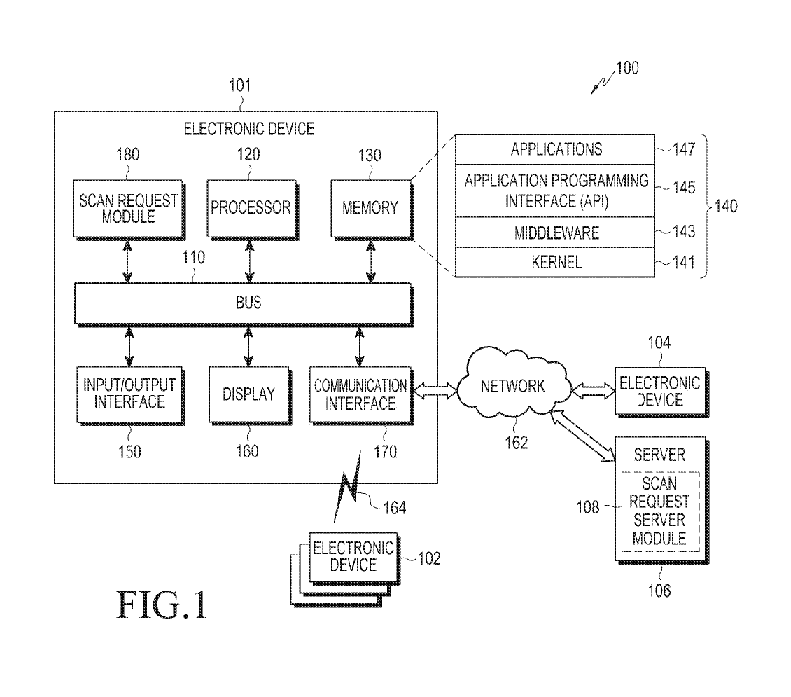

FIG. 1 is a block diagram of a network environment 100 including an electronic device 101 according to an embodiment of the present invention.

Referring to FIG. 1, the electronic device 101 may include a bus 110, a processor 120, a memory 130, an input/output interface 150, a display 160, a communication interface 170, and a scan request module 180. In an embodiment of the present invention, the electronic device 101 may omit at least some of the above components or further include other components.

The bus 110 may include a circuit for connecting the components 120 to 180 and transmitting communication between the components (for example, control messages and/or data).

The processor 120 may include one or more of a Central Processing Unit (CPU), an Application Processor (AP), and a Communication Processor (CP). The processor 120 may control, for example, one or more other components of the electronic device 101 and/or process an operation or data related to communication. The processor 120 may be referred to as a controller or may include a controller as a part thereof.

The memory 130 may include a volatile memory and/or a non-volatile memory. The memory 130 may store, for example, commands or data related to one or more other components of the electronic device 101. According to an embodiment of the present invention, the memory 130 may store software and/or a program 140. The program 140 may include a kernel 141, middleware 143, an Application Programming Interface (API) 145, and/or application programs (or “applications”) 147. At least some of the kernel 141, the middle 143, and the API 145 may be referred to as an Operating System (OS).

The kernel 141 may control or manage system resources (for example, the bus 110, the processor 120, or the memory 130) used for executing an operation or function implemented by other programs (for example, the middleware 143, the API 145, or the applications 147). Furthermore, the kernel 141 may provide an interface via which the middleware 143, the API 145, or the application programs 147 may access individual components of the electronic device 101 to control or manage system resources.

The middleware 143 may serve as, for example, an intermediary such that the API 145 or the application programs 147 communicates with the kernel 141 to transmit/receive data. Further, in relation to requests for an operation received from the application programs 147, the middleware 143 may control (for example, scheduling or load-balancing) the requests for the operation using, for example, a method of determining a sequence for using system resources (for example, the bus 110, the processor 120, the memory 130, or the like) of the electronic device 101 with respect to at least one application of the application programs 147.

The API 145 is an interface by which the applications 147 control functions provided from the kernel 141 or the middleware 143, and may include, for example, at least one interface or function (for example, instructions) for file control, window control, image processing, or text control.

In the present invention, the applications 147 may be referred to as an application program.

The input/output interface 150 may serve as an interface which can transmit commands or data input from a user or another external device to other component(s) of the electronic device 101. Further, the input/output interface 150 may output commands or data received from another component(s) of the electronic device 101 to the user or another external device.

The display 160 may include, for example, a Liquid Crystal Display (LCD), a Light Emitting Diode (LED) display, an Organic Light Emitting Diode (OLED) display, a Micro Electro Mechanical System (MEMS) display, or an electronic paper display. The display 160 may display various types of contents (for example, text, images, videos, icons, or symbols) for users. The display 160 may include a touch screen, and may receive, for example, a touch, gesture, proximity, or hovering input by using an electronic device or a part of the user's body.

The communication interface 170 may configure communication between, for example, an electronic device and an external device (for example, a first external electronic device 101, a second external electronic device 104, or a server 106). For example, the communication interface 170 may be connected to a network 162 via wireless or wired communication to communicate with the external device (for example, the external electronic device 104 or the server 106).

A first external electronic device 102 may be, for example, a beacon. The first external electronic device 102 may transmit/receive a beacon signal 164 at a preset time interval. The first external electronic device 102 may transmit/receive the beacon signal 164 based on various communication protocols such as Bluetooth, WiFi, and ANT.

Alternatively, wireless communication may include, for example, at least one of Long Term Evolution (LTE), LTE Advanced (LTE-A), Code Division Multiple Access (CDMA), Wideband CDMA (WCDMA), Universal Mobile Telephone System (UMTS), Wireless Broadband (WiBro), and Global System for Mobile communication (GSM) as a cellular communication protocol. The wired communication may include at least one of, for example, a Universal Serial Bus (USB), a High Definition Multimedia Interface (HDMI), Recommended Standard 232 (RS-232), and a Plain Old Telephone Service (POTS). The network 162 may include a telecommunications network, for example, at least one of a computer network (for example, a Local Area Network (LAN) or a Wide Area Network (WAN)), the Internet, and a telephone network.

Each of the first and second external electronic devices 102 and 104 may be a device which is the same as or different from the electronic device 101. According to an embodiment of the present invention, the server 106 may include a group of one or more servers. According to an embodiment of the present invention, all or some of the operations performed by the electronic device 101 may be performed by another electronic device or a plurality of electronic devices 102, 104 or 106). According to an embodiment of the present invention, when the electronic device 101 should perform some functions or services automatically or by request, the electronic device 101 may make a request for performing at least some of the functions related to the functions or services to another device 102, 104 or 106) instead of performing the functions or services by itself. Another electronic device 102, 104 or 106) may execute the requested functions or additional functions, and transmit a result thereof to the electronic device 101. The electronic device 101 may provide the requested functions or services based on the received result or after additionally processing the received result. In this case, for example, a cloud computing, distributed computing, or client-server computing technology may be used.

According to an embodiment of the present invention, the scan request module 180 may support driving of the electronic device 101 by performing at least one of the operations (or functions) implemented by the electronic device 101. For example, the server 106 may include a scan request server module 108 capable of supporting the scan request module 180 implemented in the electronic device 101. For example, the scan request server module 108 includes one or more components of the scan request module 180 and may perform (on behalf of the scan request module 180) at least one of operations of the scan request module 180.

The scan request module 180 may process at least some of the information obtained from other components (for example, at least one of the processor 120, the memory 130, the input/output interface 150, and the communication interface 170) and utilize the same in various manners. For example, the scan request module 180 may control at least some functions of the electronic device 101 by using the processor 120 or independently therefrom so that the electronic device 101 may work with other electronic devices (for example, the electronic device 104 or the server 106). The scan request module 180 may be integrated into the processor 120 or the communication interface 170. According to an embodiment of the present invention, at least one component of the scan request module 180 may be included in the server 106 (for example, the scan request server module 108) and receive at least one operation, which is performed by the scan request module 180, from the server 106.

FIG. 2 illustrates a method of an electronic device according to an embodiment of the present invention.

Referring to FIG. 2, short range communication may be performed between electronic devices 210, 220, 230, 240, and 250 based on a short range communication scheme such as Bluetooth Low Energy (BLE) or WiFi. For example, the electronic devices 220, 230, and 240 located within a BLE communication range and a WiFi communication range based on a smart phone 210 may perform short range communication with the smart phone 210 using a BLE scheme or a WiFi scheme. Further, a smart phone 250 which is not located within the BLE communication range based on the smart phone 210 but is located within the WiFi communication range may perform short range communication with the smart phone 210 using the WiFi scheme.

As described above, the smart phone 210 may perform short range communication with the other electronic devices 220, 230, 240, and 250 using a short range communication scheme supported by the smart phone 210. However, short range communication has a limited communication range, and communication ranges within which the short range communication is possible may vary depending on the communication scheme.

Accordingly, in order to perform short range communication, the smart phone 210 may continuously scan for electronic devices which enable the short range communication. The smart phone 210 may acquire information on electronic devices having no short range communication link by scanning the electronic devices which enable the short range communication. The smart phone 210 may make a short range communication connection with the scanned electronic devices via an available short range communication scheme based on the information acquired via the scan. However, the scan for the short range communication may consume predetermined current (for example, about 20 mA), and thus electronic devices sensitive to power consumption (for example, wearable devices) may have difficulty in continuously scanning for short range communication.

According to an embodiment of the present invention, an electronic device sensitive to power consumption may make a request for performing the scan for the short range communication to another electronic device. The electronic device having received the request for the scan may not be sensitive to power consumption in comparison with the electronic device having made the request for the scan. For example, the wearable device 220 sensitive to power consumption may make a request for performing the scan for the short range communication to the smart phone 210. In view of a battery capacity, power consumption due to the scan may not significantly influence the operations of the smart phone 210. Accordingly, the smart phone 210 may perform the scan for the short range communication on behalf of the wearable device 220. The wearable device 220 may receive a result of the scan from the smart phone 210 and perform the short range communication based on the received result of the scan. Accordingly, the wearable device 220 may reduce the current consumed by the scan for the short range communication.

According to an embodiment of the present invention, electronic devices which do not operate all the time (for example, smart TVs or tablet PCs) may make a request for performing the scan for the short range communication to other electronic devices which operate all the time (for example, smart phones). The electronic devices which do not operate all the time are cumbersome in that the scan should be started every time the electronic devices are driven for the short range communication. Accordingly, the electronic devices which do not operate all the time may make a request for performing the scan for the short range communication to other electronic devices which operate all the time. Then, the electronic devices which do not operate all the time may perform the short range communication based on a result of the scan performed by the other electronic devices without the scan performed whenever the electronic devices are driven.

Hereinafter, a detailed method of making a request for performing the scan and receiving a scan result in response to the scan request to perform short range communication is described.

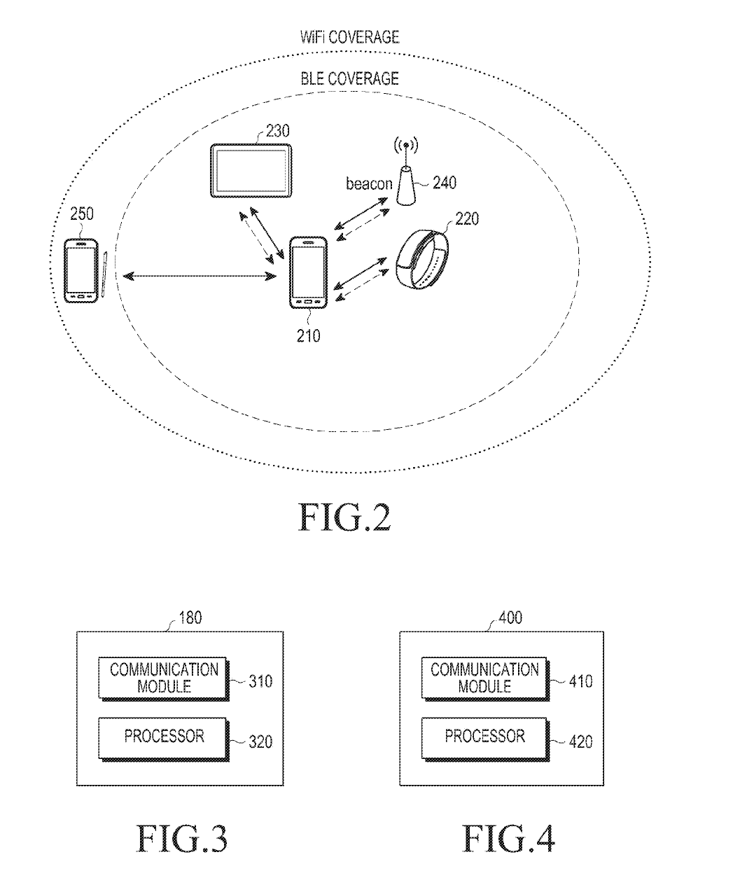

FIG. 3 is a block diagram of the scan request module of the electronic device according to an embodiment of the present invention.

Referring to FIG. 3, the scan request module 180 may include a communication module 310 and a processor 320. The scan request module 180 may be provided separately from the processor (for example, the processor 120) or may be integrated into all or some of the processor.

The communication module 310 according to an embodiment of the present invention broadcasts a request for scanning for one or more short range communication devices. The communication module 310 may receive a scan result of a scan device for the one or more short range communication devices from the scan device in response to the scan request. The scan device may be an electronic device for performing the scan according to the scan request.

According to an embodiment of the present invention, the communication module 310 may broadcast an advertisement signal including the scan request for the one or more short range communication devices. Further, the communication module 310 may receive a pairing request including a scan result corresponding to the scan request.

The processor 320 according to an embodiment of the present invention may control the communication module 310 to periodically broadcast the scan request. For example, the processor 320 controls the communication module 310 to periodically broadcast the scan request in order to transmit the scan request to electronic devices having no short range communication link.

According to an embodiment of the present invention, the processor 320 may control the communication module 310 to periodically broadcast an advertisement signal including the scan request.

According to an embodiment of the present invention, the scan request may include a scan condition for the one or more short range communication devices. The scan device may continuously scan for short range communication devices to perform the short range communication. Accordingly, the electronic device 101 may insert the scan condition for the one or more short range communication devices into the scan request to receive a scan result including short range communication devices corresponding to the scan condition.

According to an embodiment of the present invention, the scan condition may include at least one of short range communication connection information of the electronic device 101, service identification information requested by the electronic device 101, and service identification information which the electronic device 101 supports.

The service may be a Location Based Service (LBS) via short range communication. For example, the service may be a coupon service, a service providing product information, or a service providing product price information which is provided based on location information of the user determined via the short range communication.

According to an embodiment of the present invention, the short range communication connection information may include at least one of information on a short range communication capability of the electronic device 101 and state information of a short range communication module of the electronic device 101 performing the short range communication.

The information on the short range communication capability may be information on one or more short range communication schemes supported by the electronic device 101. For example, when the electronic device 101 supports a BLE type and a WiFi type short range communication, the information on the short range communication capability may be information indicating that the electronic device 101 supports the BLE type and the WiFi type short range communication. The state information of the short range communication module may be information indicating an operation state of the short range communication module. For example, the state information of the short range communication module may be information indicating an on/off state of a BLE module performing a BLE type short range communication or an on/off state of a WiFi module performing a WiFi type short range communication.

Accordingly, the electronic device 101 may receive a scan result including short range communication devices corresponding to the short range communication connection information and perform short range communication with the short range communication devices based on the scan result.

Further, the electronic device 101 may receive a scan result including short range communication devices which transmit a beacon signal including service identification information requested by the electronic device 101 and service identification information which the electronic device 101 supports. Based on the scan result, the electronic device 101 may perform short range communication with the short range communication device which transmits the beacon signal or make a request for a service to the short range communication devices which transmit the beacon signal.

As described above, the electronic device 101 may insert the scan condition for the one or more short range communication devices into the scan request to receive a scan result including short range communication devices corresponding to the scan condition.

According to an embodiment of the present invention, the processor 320 may control the communication module 310 to make a request for a short range communication connection via first short range communication supported by a first short range communication device to the first short range communication device included in the scan result. For example, when the first short range communication device supports a BLE type short range communication, the processor 320 controls the communication module 310 to make a request for short range communication to the first short range communication device via the BLE type short range communication. Further, when the first short range communication device supports a WiFi type short range communication, the processor 320 controls the communication module 310 to make a request for short range communication to the first short range communication device via the WiFi type short range communication.

According to an embodiment of the present invention, the processor 320 may control execution of a first application corresponding to a first beacon signal transmitted by the first short range communication device included in the scan result. For example, when service identification information included in the first beacon signal indicates a service of company A, the processor 320 controls execution of a first application corresponding to the service of company A.

According to an embodiment of the present invention, the processor 320 may control the communication module 310 to make a request for a first service corresponding to the first beacon signal to at least one of the first short range communication device which transmits the first beacon signal included in the scan result and a server which provides the first service. For example, when the service identification information included in the first beacon signal indicates a first service of company A, the electronic device 101 makes a request for the first service.

During a process of making a request for the first service, the electronic device 101 may make a short range communication connection or a wireless communication connection with at least one of the first short range communication device which makes a request for the first service and the server to receive the first service.

According to an embodiment of the present invention, the electronic device 101 may make a request for the first service to the first short range communication device. In this case, the electronic device 101 may make a short range communication connection with the first short range communication device to receive the first service. Further, when the electronic device can make a connection with the server, the electronic device 101 may make a request for the first service to the server. In this case, the electronic device 101 may receive the first service from the server via wireless communication. Further, the electronic device 101 may make a request for the first service to both the first short range communication device and the server.

The communication module 310 may receive the first service from at least one of the first short range communication device and the server according to a request for the first service.

According to an embodiment of the present invention, the processor 320 may control the communication module 310 to make a request for the first service corresponding to the first beacon signal transmitted by the first short range communication device included in the scan result to the scan device. When the electronic device 101 cannot directly receive the first service, the electronic device 101 may make a request for the first service to the scan device. The communication module 310 may receive the first service from the scan device.

As described above, when the electronic device 101 cannot directly receive the first service, the electronic device 101 may make a request for receiving the first service to the scan device and receive the first service from the scan device having received the first service. In this case, the electronic device 101 may make a short range communication connection with the scan device to receive the first service from the scan device. A time when the short range communication connection with the scan device is made may be a time when the first service is requested or a time when the first service is received.

FIG. 4 is a block diagram of a scan device 400 according to an embodiment of the present invention.

Referring to FIG. 4, the scan device 400 may include a communication module 410 and a processor 420.

The communication module 410 according to an embodiment of the present invention may receive a request for scanning for one or more short range communication devices periodically broadcast from the electronic device 101. Further, the communication module 410 may transmit a result of the scan for the one or more short range communication devices to the electronic device 101.

The processor 420 according to an embodiment of the present invention may control the communication module 410 to transmit the scan result for the one or more short range communication devices to the electronic device 101 in response to the scan request.

In a state where short range communication with the electronic device 101 is not made, the scan device 400 may receive a scan request periodically broadcast from the electronic device 101 and may perform the scan on behalf of the electronic device 101. The scan device 400 may perform the scan after an authentication process with the electronic device 101 in response to the periodically broadcast scan request.

According to an embodiment of the present invention, the scan request may include a scan condition for the one or more short range communication devices. The scan condition may include at least one of short range communication connection information of the electronic device 101, service identification information requested by the electronic device 101, and service identification information which the electronic device 101 supports.

According to an embodiment of the present invention, the processor 420 may generate the scan result based on the scan condition among results of the scan performed for the short range communication devices by the scan device 400. Accordingly, the scan device 400 may transmit the scan result for the short range communication devices corresponding to the scan condition included in the scan request of the electronic device 101 without transmitting all of the results of the scan to the electronic device 101.

According to an embodiment of the present invention, the scan result may include short range communication devices corresponding to the short range communication connection information included in the scan condition. Accordingly, the scan device 400 may generate the scan result including short range communication devices which can perform short range communication with the electronic device 101. Further, when there is a scan request conventionally made from the electronic device 101 and a scan condition included in the scan request does not change, the scan device 101 may transmit a conventionally generated scan result to the electronic device 101 without generating a separate scan result.

According to an embodiment of the present invention, the scan result may include a short range communication device which transmits a beacon signal including at least one of service identification information requested from the scan request device and service identification information which the scan request device supports. Accordingly, the scan device 400 generates the scan result including the short range communication device which provides a beacon signal for a service requested from or which the electronic device 101 supports.

According to an embodiment of the present invention, the communication module 410 may receive a first service corresponding to a first beacon signal transmitted from a first short range communication device included in the scan result. The scan device 400 may not only perform the scan on behalf of the electronic device 101 but also receive the first service on behalf of the electronic device 101. In this case, the scan device 400 may make a short range communication connection with the electronic device 101 to transmit the first service to the electronic device 101.

In response to the request for the first service, the processor 420 may control the communication module 410 to make a request for the first service to at least one of the first short range communication device and a server which provides the first service.

The communication module 410 may receive the first service from at least one of the first short range communication device and the server. After receiving the first service, the processor 420 may control the communication module 410 to transmit the first service to the electronic device 101.

As described above, the scan device 400 may scan for one or more short range communication devices on behalf of the electronic device 101, receive a service requested from the electronic device 101 or a service which the electronic device 101 supports on behalf of the electronic device 101, and transmit the received service to the electronic device 101.

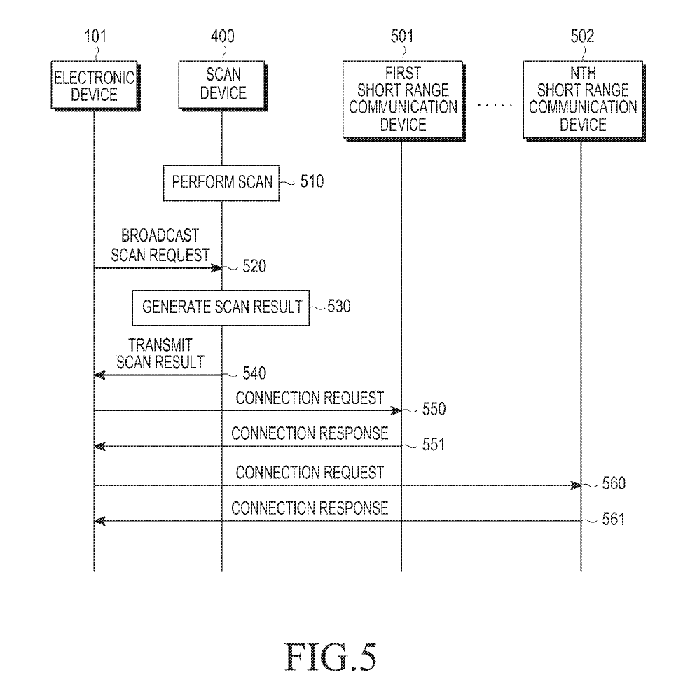

FIG. 5 is a flowchart of a short range communication connection method of the electronic device according to an embodiment of the present invention.

Referring to FIG. 5, a method in which the electronic device 101 makes a short range communication connection with short range communication devices 501 and 502 based on a scan result received in response to a scan request is described below. It is assumed that a first short range communication device 501 is a short range communication device which supports only first short range communication used for broadcasting a scan request from the electronic device 101. Further, it is assumed that an Nth short range communication device 502 is a short range communication device which supports only second short range communication that has a short range communication scheme different from that of the first short range communication but supports only second short range communication supported by the electronic device 101.

In step 510, the scan device 400 may scan for adjacent short range communication devices. The scan device 400 may continuously scan for the short range communication devices even before receiving a scan request from the electronic device 101.

In step 520, the electronic device 101 may periodically broadcast a request for scanning for one or more short range communication devices. The electronic device 101 may periodically broadcast the scan request to make a request for the scan to the scan device 400 having no short range communication link. The scan request may be broadcast using at least one short range communication supported by the electronic device 101. For example, the scan request may be broadcast via BLE type short range communication or via WiFi type short range communication.

In step 530, the scan device 400 may generate a scan result for the one or more short range communication devices in response to the scan request. The scan request may include a scan condition for the one or more short range communication devices. The scan condition may include at least one of short range communication connection information of the electronic device 101, service identification information requested by the electronic device 101, and service identification information which the electronic device 101 supports.

The scan device 400 may generate the scan result based on the scan condition among results of the scan performed for the adjacent short range communication devices in step 510.

According to an embodiment of the present invention, the scan device 400 may configure a scan filter based on the scan condition, and may filter the results of the scan for the adjacent short range communication devices performed in step 510 via the scan filter.

According to an embodiment of the present invention, the scan device 400 may generate the scan result which includes short range communication devices corresponding to the short range communication connection information of the electronic device 101. For example, the scan device 400 filters short range communication devices which cannot perform short range communication with the electronic device 101 based on the short range communication connection information of the electronic device 101. Accordingly, the scan device 400 may allow only the short range communication devices, which can perform the short range communication with the electronic device, to be included in the scan result.

Specifically, the scan device 101 may allow only the short range communication devices, which can perform the short range communication via a short range communication scheme supported by the electronic device 101, to be included in the scan result. In this case, the scan device 400 may generate the scan result by filtering the scan results in step 510 based on information on a short range communication capability of the electronic device 101.

Further, the scan device 101 may allow only the short range communication devices, which can perform the short range communication via a short range communication scheme supported by a short range communication module in an on state, to be included in the scan result based on state information of the short range communication module. In this case, the scan device 400 may generate the scan result by filtering the scan results in step 510 based on the state information of the short range communication module of the electronic device 101.

A method in which the scan device 400 generates the scan result based on service identification information requested from the electronic device 101 and service identification information which the electronic device 101 supports is described below.

According to an embodiment of the present invention, the scan device 400 may generate the scan result by additionally scanning for the one or more short range communication devices based on the scan condition.

According to an embodiment of the present invention, when there is a scan request conventionally made from the electronic device 101 and a scan condition included in the scan request does not change, the scan device 101 may transmit a conventionally generated scan result to the electronic device 101 without a separate operation for generating the scan result.

In step 540, the scan device 400 may transmit the scan result to the electronic device 101. As described above, the scan device 400 may transmit the scan result corresponding to a scan condition included in the scan request to the electronic device 101.

In step 550, the electronic device 101 may make a request for a short range communication connection to the first short range communication device 501 included in the received scan result. As described above, since the first short range communication device 501 supports the first short range communication used for broadcasting the scan request, the first short range communication device 501 may correspond to the short range communication connection information. Accordingly, the scan device 400 may allow the first short range communication device 501 to be included in the scan result.

In step 551, the first short range communication device 501 may transmit a connection response to the electronic device 101 in response to the connection request. Accordingly, the electronic device 101 and the first short range communication device 501 may make the short range communication connection using the first short range communication.

In step 560, the electronic device 101 may make a request for a short range communication connection to the Nth short range communication device 502 included in the received scan result. As described above, the Nth short range communication device 502 may support only the second short range communication having a short range communication scheme different from that of the first short range communication. Since the second short range communication is a short range communication supported by the electronic device 101, the Nth short range communication device 502 may correspond to the short range communication connection information of the electronic device 101. Accordingly, the scan device 400 may allow the Nth short range communication device 502 to be included in the scan result.

In step 561, the Nth short range communication device 502 may transmit a connection response to the electronic device 101 in response to the connection request. Accordingly, the electronic device 101 and the Nth short range communication device 502 may make the short range communication connection using the second short range communication. As described above, the electronic device 101 may also make the short range communication connection via the second short range communication having a short range communication scheme different from that of the first short range communication used for broadcasting the scan request.

The electronic device 101 may transmit the connection request to all the short range communication devices included in the scan result. Alternatively, the electronic device 101 may transmit the connection request to only one short range communication device among all the short range communication devices included in the scan result. For example, the electronic device 101 may transmit the connection request only to the first short range communication device 501 or only to the Nth short range communication device 502.

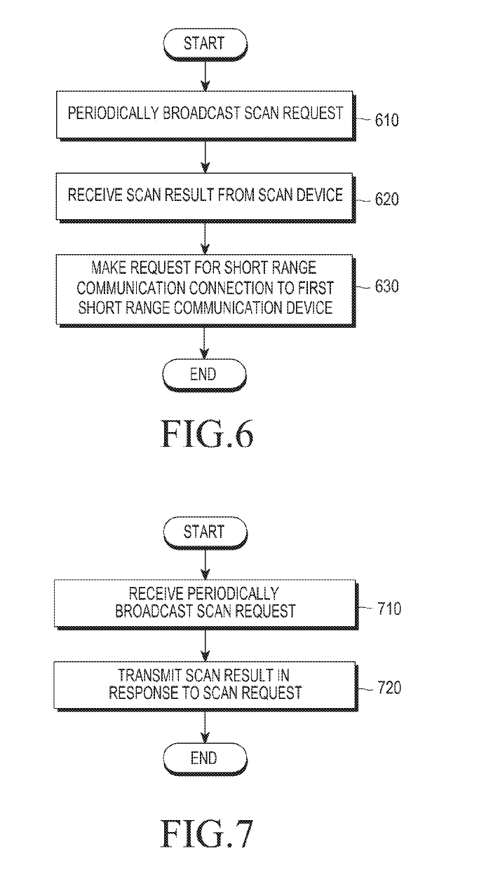

FIG. 6 is a flowchart of a method of the electronic device according to an embodiment of the present invention.

Referring to FIG. 6, in step 610, the electronic device 101 may periodically broadcast a request for scanning for one or more short range communication devices. The scan request may be broadcast using at least one short range communication supported by the electronic device 101.

In step 620, the electronic device 101 may receive a scan result of the scan device 400 for the one or more short range communication devices from the scan device 400 in response to the scan request. The electronic device 101 may receive the scan result corresponding to a scan condition included in the scan request, from the scan device 400.

In step 630, the electronic device 101 may make a request for a short range communication connection to a first short range communication device 501 included in the scan result. The electronic device 101 may transmit the short range communication connection request to each of the short range communication devices included in the scan result or may transmit the short range communication connection request to only one or more short range communication devices included in the scan result.

FIG. 7 is a flowchart of a method of the scan device according to an embodiment of the present invention.

Referring to FIG. 7, in step 710, the scan device 400 may receive a scan request for one or more short range communication devices periodically broadcast from the electronic device 101. According to an embodiment of the present invention, the scan device 400 may receive the scan request, pass through an authentication process for the electronic device 101, and then scan the one or more short range communication devices or generate a scan result.

In step 720, the scan device 400 may transmit the scan result for the one or more short range communication devices to the electronic device 101 in response to the scan request. According to an embodiment of the present invention, the scan device 400 may generate the scan result based on a scan condition included in the scan request among results of the scan performed for adjacent short range communication devices. Further, the scan device 400 may generate the scan result by additionally scanning for the one or more short range communication devices based on the scan condition.

The scan device 400 may transmit the generated scan result to the electronic device 101. As described above, the scan device 400 may perform the scan on behalf of the electronic device 101 by transmitting the scan result corresponding to the scan condition included in the scan request to the electronic device 101.

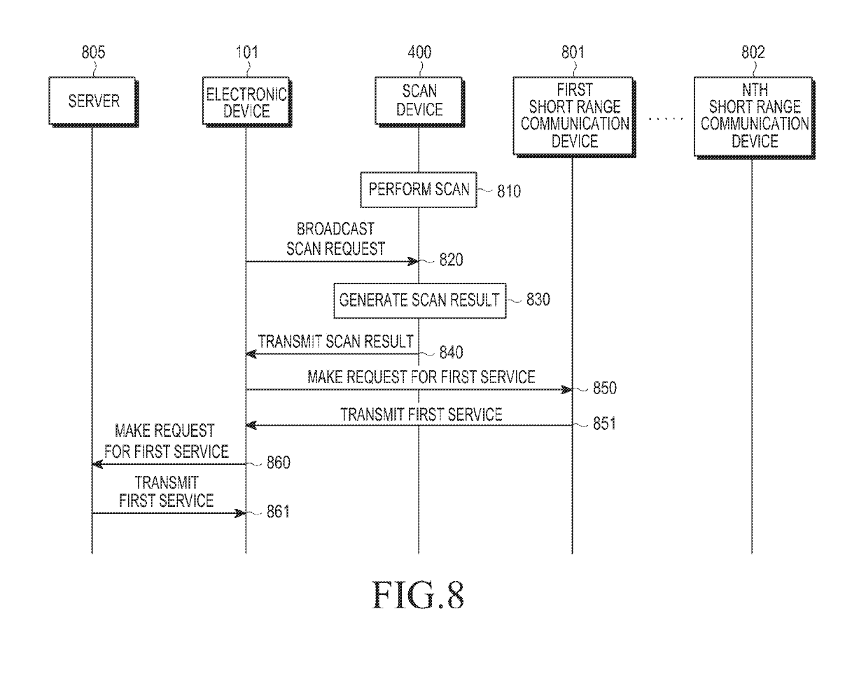

FIG. 8 is a flowchart of a method in which an electronic device 101 receives a service according to an embodiment of the present invention.

Referring to FIG. 8, a method in which the electronic device 101 receives a service from at least one of short range communication devices 801 and 802, and a server 810 based on a scan result received in response to a scan request transmitted to the scan device 400 is described below. It is assumed that a first short range communication device 801 is a device which transmits a first beacon signal including at least one of service identification information requested from the electronic device 101 and service identification information which the electronic device 101 supports. Further, it is assumed that an Nth beacon signal transmitted by an Nth short range communication device 802 does not include the service identification information.

In step 810, the scan device 400 may scan for adjacent short range communication devices. As described above, the scan device 400 may continuously scan for the adjacent short range communication devices even before receiving a scan request from the electronic device 101.

In step 820, the electronic device 101 may periodically broadcast a request for scanning for one or more short range communication devices. The electronic device 101 may periodically broadcast the scan request to make a request for the scan to the scan device 400 having no short range communication link.

In step 830, the scan device 400 may generate a scan result for the one or more short range communication devices in response to the scan request. The scan request may include a scan condition for the one or more short range communication devices. The scan condition may include at least one of short range communication connection information of the electronic device 101, service identification information requested by the electronic device 101, and service identification information which the electronic device 101 supports.

The scan device 400 may generate the scan result based on the scan condition among results of the scan performed for the adjacent short range communication devices in step 510. Further, the scan device 400 may configure a scan filter according to the scan condition. The scan device 400 may generate the scan result based on the scan condition among results of the scan performed for the adjacent short range communication devices.

According to an embodiment of the present invention, the electronic device 400 may generate a scan result including short range communication devices corresponding to at least one of service identification information requested by the electronic device 101 and service identification information which the electronic device 101 supports. For example, the scan device 400 filters short range communication devices which do not correspond to the service identification information.

Specifically, the scan device 101 may allow only the short range communication devices which transmit a beacon signal including at least one piece of the service identification information to be included in the scan result. In this case, the scan device 400 may filter the results of the scan performed in step 810 based on at least one of the service identification information supported by the electronic device 101 and the service identification information requested from the electronic device 101 so as to generate the scan result.

For example, the scan device 400 inserts the first short range communication device 801, which transmits a first beacon signal including at least one piece of the service identification information into the scan result, and filters the Nth short range communication device 802, which transmits an Nth beacon signal having no service identification information, so as not to insert the Nth short range communication device 802 into the scan result.

According to an embodiment of the present invention, the scan device 400 may generate the scan result by additionally scanning for one or more short range communication devices based on the service identification information.

In step 840, the scan device 400 may transmit the scan result to the electronic device 101.

In step 850, the electronic device 101 may make a request for a first service corresponding to the first beacon signal transmitted from the first short range communication device 801 included in the scan result to the short range communication device 801. As described above, the first service may be an LBS. When the first beacon signal corresponding to the first service can be received via short range communication, the electronic device 101 may make a request for the first service corresponding to the first beacon signal.

When the first short range communication device 801 directly provides the first service, the electronic device 101 may make a request for the first service to the first short range communication device 801.

In step 851, the first short range communication device 801 may transmit the first service to the electronic device 101 in response to the request for the first service.

In step 860, the electronic device 101 may make a request for the first service to a server 805 which provides the first service. When the first short range communication device 801 provides the first service via the server 805 without directly providing the first service, the electronic device 101 may make a request for the first service to the server 805. For example, when the first short range communication device 801 is a beacon which transmits only the first beacon signal, the first short range communication device 801 may not directly provide the first service. In this case, the electronic device 101 may make a request for the first service to the server 805 (for example, a cloud) which provides the first service.

In step 861, the server 805 may transmit the first service to the electronic device 101 in response to the request for the first service.

As described above, the electronic device 101 may make a request for the first service to both the first short range communication device 801 and the server 805. Further, the electronic device 101 may make a request for the first service only to the server 805 or make a request for the first service only to the first short range communication device 801 according to a characteristic of the first short range communication device 801. As described above, the electronic device 101 may receive the service based on the scan result.

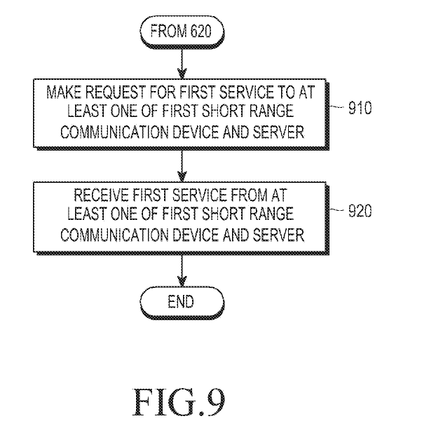

FIG. 9 is a flowchart of a method of an electronic device 101 according to an embodiment of the present invention.

Referring to FIG. 9, in step 910, the electronic device 101 may make a request for a first service corresponding to a first beacon signal to at least one of a first short range communication device which transmits the first beacon signal included in a scan result and a server which provides the first service. The electronic device 101 may make a request for the first service to at least one of the first short range communication device and the server based on a characteristic of the first short range communication device.

In step 920, the electronic device 101 may receive the first service from at least one of the first short range communication device and the server.

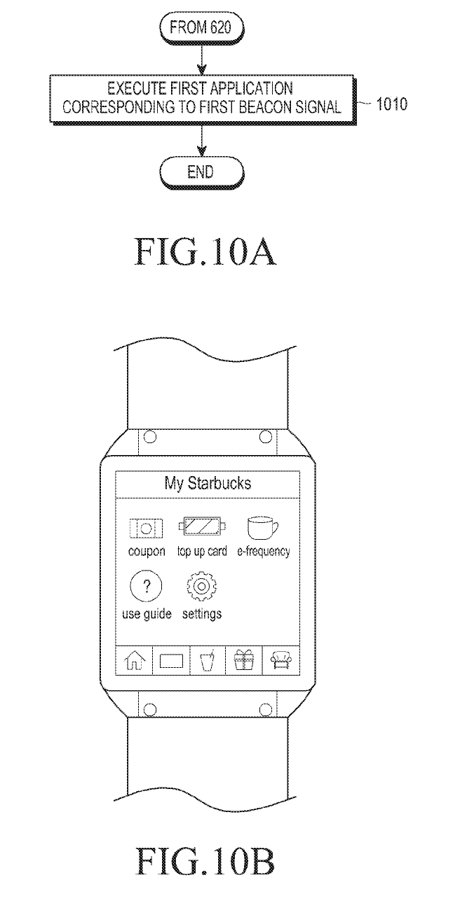

FIG. 10A is a flowchart of a method of an electronic device 101 according to an embodiment of the present invention.

Referring to FIG. 10A, in step 1010, the electronic device 101 may execute a first application corresponding to a first beacon signal transmitted by the first short range communication device included in the scan result.

As described above, the electronic device 101 makes a request for the first service corresponding to the first beacon signal or executes the first application corresponding to the first beacon signal as illustrated in step 1010. The electronic device 101 automatically executes the application corresponding to the first service based on the first beacon signal transmitted from the scanned first short range communication device. Accordingly, the electronic device 101 executes an application corresponding to a requested service which can be supported based on the scan result.

FIG. 10B illustrates a screen in which an application is executed by an electronic device 101 according to an embodiment of the present invention.

Referring to FIG. 10B, the electronic device 101 executes a first application corresponding to a first beacon signal. For example, when a user of the electronic device 101 visits “Starbucks,” the scan device 400 transmits a scan result including a first short range communication device installed in the “Starbucks” to the electronic device 101 in response to the scan result from the electronic device 101. The electronic device 101 executes a first application corresponding to a first beacon signal transmitted by a first short range communication device, for example, a “Starbucks” application based on the scan result as illustrated in FIG. 10B. As described above, the electronic device 101 executes a proper application based on the scan result received according to a location of the user.

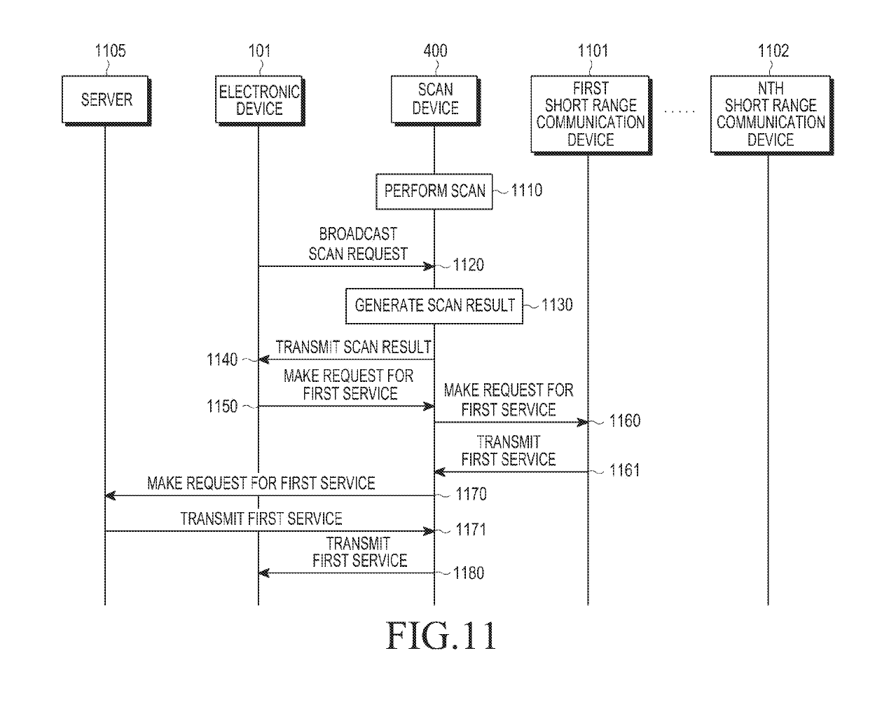

FIG. 11 is a flowchart of a method in which the electronic device 101 receives a service according to an embodiment of the present invention.

Referring to FIG. 11, a method in which the electronic device 101 receives a service from the scan device 400 based on a scan result received in response to a scan request transmitted to the scan device 400 is described below. When the electronic device 101 cannot directly receive the service, the electronic device 101 may make a request for receiving the service to the scan device 400 on behalf of the electronic device 101. According to an embodiment of the present invention, the electronic device 101 may make a short range communication connection with the scan device 400 to receive the service from the scan device 400. The short range communication connection with the scan device 400 may be made after the scan result is received or before the scan result is received after the scan request.

It is assumed that a first short range communication device 1101 is a device which transmits a first beacon signal including at least one of service identification information requested from the electronic device 101 and service identification information which the electronic device 101 supports. Further, it is assumed that an Nth beacon signal transmitted by an Nth short range communication device 1102 does not include the service identification information.

In step 1110, the scan device 400 may scan for adjacent short range communication devices.

In step 1120, the electronic device 101 may periodically broadcast a request for scanning for one or more short range communication devices. The electronic device 101 may periodically broadcast the scan request to make a request for the scan to the scan device 400 having no short range communication link.

In step 1130, the scan device 400 may generate a scan result for the one or more short range communication devices in response to the scan request. A detailed method in which the scan device 400 generates the scan result may be performed in the same manner as in step 830 of FIG. 8.

In step 1140 of FIG. 11, the scan device 400 may transmit the scan result to the electronic device 101.

In step 1150, the electronic device 101 may make a request for a first service corresponding to the first beacon signal transmitted from the first short range communication device 1101 included in the scan result to the scan device 400. As described above, when the electronic device 101 cannot directly receive the first service, for example, when the electronic device 101 does not support communication for receiving the first service or short range communication, the electronic device 101 may make a request for receiving the first service on behalf of the electronic device 101 to the scan device 400.

In step 1160, the scan device 400 may make a request for the first service to the first short range communication device 1101. When the first short range communication device 1101 directly provides the first service, the scan device 400 may make a request for the first service to the first short range communication device 1101.

In step 1161, the first short range communication device 1101 may transmit the first service to the scan device 400 in response to the request for the first service.

In step 1170, the scan device 400 may make a request for the first service to a server 1105 which provides the first service. When the first short range communication device 1101 provides the first service via the server 1105 without directly providing the first service, the electronic device 101 may make a request for the first service to the server 1105.

In step 1171, the server 1105 may transmit the first service to the scan device 400 in response to the request for the first service.

In step 1180, the scan device 400 may transmit the first service received from at least one of the first short range communication device 1101 and the serer 1105 to the electronic device 101.

As described above, the scan device 101 may make a request for the first service to both the first short range communication device 1101 and the server 1105 in response to the request for the first service received from the electronic device 101. Further, the scan device 400 may make a request for the first service only to the server 1105 or make a request for the first service only to the first short range communication device 1101 according to a characteristic of the first short range communication device 1101. As described above, the scan device 400 may receive the first service on behalf of the electronic device 101 and transmit the first service to the electronic device 101.

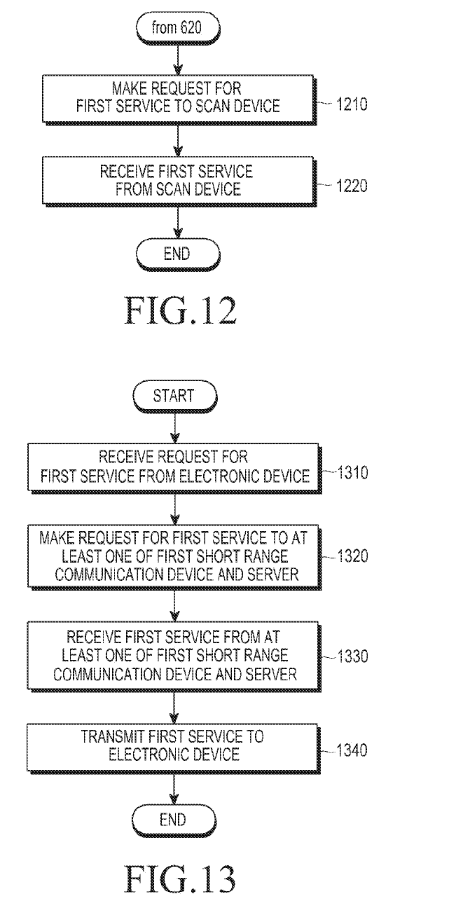

FIG. 12 is a flowchart of a method of an electronic device 101 according to an embodiment of the present invention.

Referring to FIG. 12, in step 1210, the electronic device 101 may make a request for a first service corresponding to a first beacon signal transmitted from a first short range communication device included in a scan result to the scan device 400. When the electronic device 101 cannot directly receive the first service, the electronic device 101 may make a request for receiving the first service on behalf of the electronic device 101 to the scan device 400.

In step 1220, the electronic device 101 may receive the first service from the scan device 400. Accordingly, even though the electronic device 101 cannot receive the first service from at least one of the first short range communication device and the server, the electronic device 101 may receive the first service via the scan device 400.

FIG. 13 is a flowchart of a method of a scan device 400 according to an embodiment of the present invention.

Referring to FIG. 13, in step 1310, the scan device 400 may receive a request for a first service corresponding to a first beacon signal transmitted from a first short range communication device included in a scan result from an electronic device 101. When the electronic device 101 cannot directly receive the first service, the scan device 400 may receive a request for receiving the first service on behalf of the electronic device 101 from the electronic device 101.

In step 1320, the scan device 400 may make a request for the first service to at least one of the first short range communication device and a server which provides the first service. When the first short range communication device 1101 directly provides the first service, the scan device 400 may make a request for the first service to the first short range communication device 1101. When the first short range communication device 1101 provides the first service via the server 1105 without directly providing the first service, the electronic device 101 may make a request for the first service to the server 1105.

In step 1330, the scan device 400 may receive the first service from at least one of the first short range communication device and the server.

In step 1340, the scan device 400 may transmit the first service to the electronic device 101.

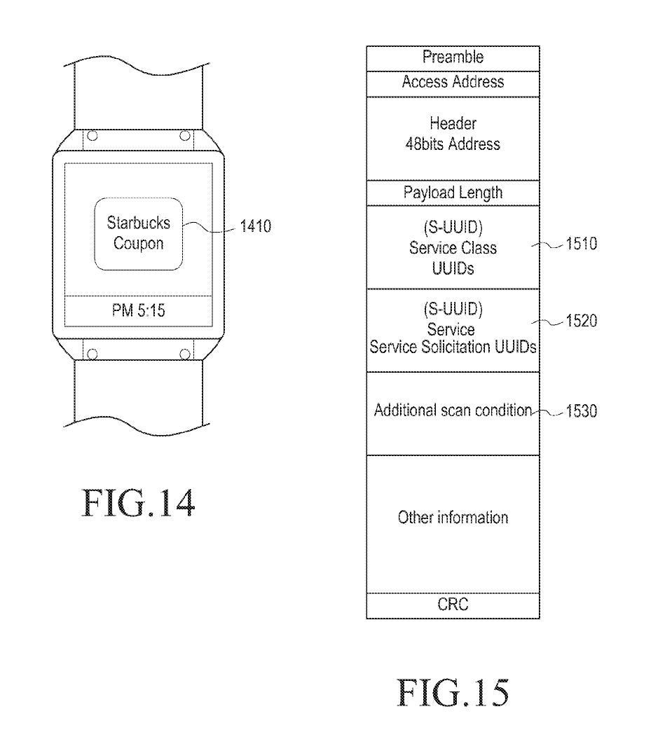

FIG. 14 illustrates an electronic device 101 displaying a received service according to an embodiment of the present invention.

Referring to FIG. 14, the electronic device 101 may receive a first service and display the received first service on a display of the electronic device 101. For example, when a user of the electronic device 101 visits “Starbucks,” the electronic device 101 receives a scan result including a first short range communication device installed in the “Starbucks” from the scan device 400. In this case, the electronic device 101 receives the first service from the first short range communication device or a server which provides the first service. Further, the electronic device 101 makes a request for receiving the first service on behalf of the electronic device 101 to the scan device 400.

According to an embodiment of the present invention, the first service may be an LBS or a coupon providing service 1410 included in the LBS provided by the “Starbucks” as illustrated in FIG. 14. In this case, the electronic device 101 receives the coupon and displays the received coupon on the display.

FIG. 15 illustrates a scan request packet of an electronic device 101 according to an embodiment of the present invention.

According to an embodiment of the present invention, the electronic device 101 may periodically broadcast a scan request via a BLE scheme. The scan request packet may be configured as illustrated in FIG. 15. The scan request packet may include service identification information 1510 which the electronic device 101 supports, service identification information 1520 requested from the electronic device 101, and an additional scan condition 1530. The additional scan condition 1530 may include short range communication connection information of the electronic device 101. For example, the additional scan condition 1530 may include information on a short range communication capability of the electronic device 101 and state information of a short range communication module of the electronic device 101. Further, the additional scan condition 1530 may further include information for the short range communication connection such as a communication method of the electronic device 101, a frequency band, a Media Access Control (MAC) address, manufacturer information of the electronic device 101, a name of the electronic device 101, a signal strength, a Class of Device (CoD), sensor information, a expiration time, channel information and the like.

The scan request packet illustrated in FIG. 15 is only an example for the description, and the present invention is not limited thereto. The scan request may be included in various signals (for example, an advertisement signal and the like) used for BLE type short range communication. Further, when the electronic device 101 periodically broadcasts the scan request via a WiFi scheme, not the BLE scheme, a packet of the scan request is configured based on a format used for the WiFi type short range communication.

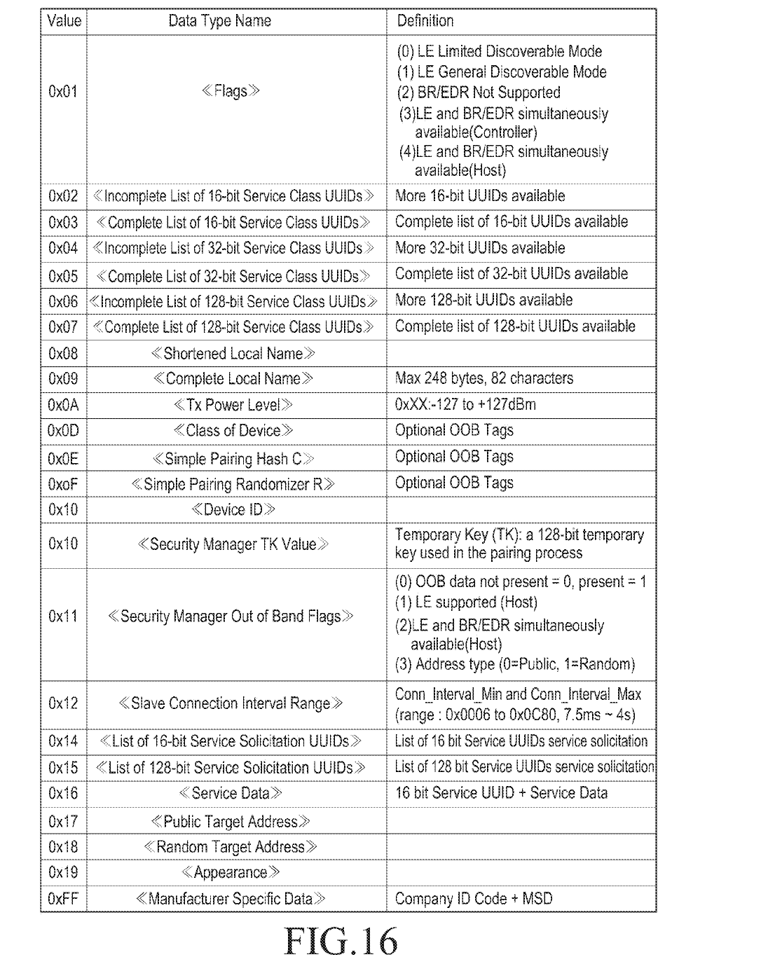

FIG. 16 is a table showing scan conditions according to an embodiment of the present invention.

Referring to FIG. 16, the scan conditions described in FIG. 15 may be inserted into the scan request, so as to be periodically broadcast by the electronic device 101 in a table or list form illustrated in FIG. 16. The table is as illustrated in FIG. 16. The table corresponds to part of a general access profile used for Bluetooth. As described above, the scan condition may be configured using the format used for short range communication.

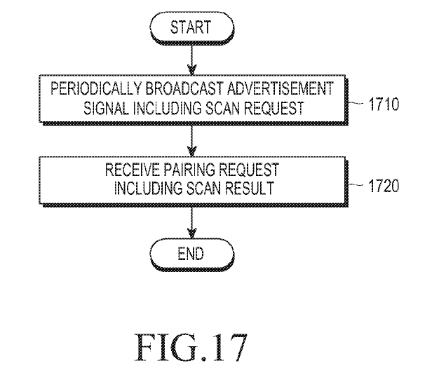

FIG. 17 is a flowchart of a method of an electronic device 101 according to an embodiment of the present invention.

In step 1710, the electronic device 101 may periodically broadcast an advertisement signal including a scan request for one or more short range communication devices. When the electronic device 101 periodically broadcasts the scan request via a BLE scheme, the scan request may be inserted into the advertisement signal used for a BLE type short range communication.

In step 1720, the electronic device 101 may receive a pairing request including a scan result corresponding to the scan request from the scan device 400 in response to the scan request.

As described above, the electronic device 101 may make a request for the scan via a signal used for short range communication and receive a scan result from the scan device 400 in response to the scan request.

According to an embodiment of the present invention, a method of an electronic device making a request for a scan via short range communication may include periodically broadcasting a scan request for one or more short range communication devices; and receiving a scan result of a scan device for the one or more short range communication devices from the scan device in response to the scan request.

According to an embodiment of the present invention, the scan request may include a scan condition for the one or more short range communication devices.

According to an embodiment of the present invention, the scan condition may include at least one of short range communication connection information of the electronic device, service identification information requested from the electronic device, and service identification information which the electronic device supports.

According to an embodiment of the present invention, the short range communication connection information may include at least one of information on a short range communication capability of the electronic device and state information of a short range communication module of the electronic device performing the short range communication.

According to an embodiment of the present invention, the scan result may include a short range communication device corresponding to the scan condition.

According to an embodiment of the present invention, the method of the electronic device may further include making a request for a short range communication connection using first short range communication supported by a first short range communication device included in the scan result to the first short range communication device.

According to an embodiment of the present invention, the method of the electronic device may further include executing a first application corresponding to a first beacon signal transmitted by a first short range communication device included in the scan result.

According to an embodiment of the present invention, the method of the electronic device may further include making a request for a first service corresponding to a first beacon signal included in the scan result to at least one of a first short range communication device transmitting the first beacon signal and a server providing a first service corresponding to the first beacon signal.

According to an embodiment of the present invention, the method of the electronic device may further include receiving the first service from at least one of the first short range communication device and the server.

According to an embodiment of the present invention, the method of the electronic device may further include making a request for a first service corresponding to a first beacon signal transmitted from a first short range communication device included in the scan result to the scan device.

According to an embodiment of the present invention, the operation method of the electronic device may further include an operation for receiving the first service from the scan device.

According to an embodiment of the present invention, an electronic device making a request for a scan via short range communication may include a communication module that broadcasts a scan request for one or more short range communication devices and receives a scan result of a scan device for the one or more short range communication devices from the scan device in response to the scan request; and a processor that controls the communication module to periodically broadcast the scan request.

According to an embodiment of the present invention, the scan request may include a scan condition for the one or more short range communication devices.

According to an embodiment of the present invention, the scan condition may include at least one of short range communication connection information of the electronic device, service identification information requested from the electronic device, and service identification information which the electronic device supports.

According to an embodiment of the present invention, the short range communication connection information may include at least one of information on a short range communication capability of the electronic device and state information of a short range communication module of the electronic device performing the short range communication.

According to an embodiment of the present invention, the scan result may include a short range communication device corresponding to the scan condition.

According to an embodiment of the present invention, the processor may control the communication module to make a request for a short range communication connection using first short range communication supported by a first short range communication device included in the scan result to the first short range communication device.

According to an embodiment of the present invention, the processor may control an execution of a first application corresponding to a first beacon signal transmitted by a first short range communication device included in the scan result.

According to an embodiment of the present invention, the processor may control the communication module to make a request for a first service corresponding to a first beacon signal included in the scan result to at least one of a first short range communication device transmitting the first beacon signal and a server providing a first service corresponding to the first beacon signal.

According to an embodiment of the present invention, the communication module may receive the first service from at least one of the first short range communication device and the server.

According to an embodiment of the present invention, the processor may control the communication module to make a request for a first service corresponding to a first beacon signal transmitted from a first short range communication device included in the scan result to the scan device.

According to an embodiment of the present invention, the communication module may receive the first service from the scan device.

According to an embodiment of the present invention, a method of an electronic device performing a scan via short range communication may include receiving a scan request for one or more short range communication devices periodically broadcast from a scan request device; and transmitting a scan result for the one or more short range communication devices to the scan request device in response to the scan request.

According to an embodiment of the present invention, the scan request may include a scan condition for the one or more short range communication devices.

According to an embodiment of the present invention, the scan condition may include at least one of short range communication connection information of the scan request device, service identification information requested from the scan request device, and service identification information which the scan request device supports.

According to an embodiment of the present invention, the short range communication connection information may include at least one of information on a short range communication capability of the scan request device and state information of a short range communication module of the scan request device performing the short range communication.

According to an embodiment of the present invention, the operation for transmitting the scan result may include generating the scan result based on the scan condition among results of the scan preformed for the short range communication devices by the electronic device.

According to an embodiment of the present invention, the scan result may include a short range communication device corresponding to the short range communication connection information.

According to an embodiment of the present invention, the scan result may include a short range communication device transmitting a beacon signal corresponding to at least one piece of service identification information requested from the scan request device, service identification information which the scan request device supports.

According to an embodiment of the present invention, the method of the electronic device may further include receiving a request for a first service corresponding to a first beacons signal transmitted from a first short range communication device included in the scan result.

According to an embodiment of the present invention, the method of the electronic device may further include making a request for the first service to at least one of the first short range communication device and a server which provides the first service based on the request for the first service.

According to an embodiment of the present invention, the method of the electronic device may further include receiving the first service from at least one of the first short range communication device and the server.

According to an embodiment of the present invention, the method of the electronic device may further include transmitting the first service to the scan request device.

According to an embodiment of the present invention, an electronic device performing a scan via short range communication may include a communication module that receives a scan request for one or more short range communication devices periodically broadcast from a scan request device and transmits a scan result for the one or more short range communication devices to the scan request device in response to the scan request; and a processor that controls transmitting a scan result for the one or more short range communication devices to the scan request device in response to the scan request.

According to an embodiment of the present invention, the scan request may include a scan condition for the one or more short range communication devices.

According to an embodiment of the present invention, the scan condition may include at least one of short range communication connection information of the scan request device, service identification information requested from the scan request device, and service identification information which the scan request device supports.

According to an embodiment of the present invention, the short range communication connection information may include at least one of information on a short range communication capability of the scan request device and state information of a short range communication module of the scan request device performing the short range communication.

According to an embodiment of the present invention, the processor may generate the scan result based on the scan condition among results of the scan preformed for the short range communication devices by the electronic device.

According to an embodiment of the present invention, the scan result may include a short range communication device corresponding to the short range communication connection information.

According to an embodiment of the present invention, the scan result may include a short range communication device transmitting a beacon signal corresponding to at least one piece of service identification information requested from the scan request device, service identification information which the scan request device supports.

According to an embodiment of the present invention, the communication module may receive a request for a first service corresponding to a first beacon signal transmitted from a first short range communication device included in the scan result.

According to an embodiment of the present invention, the processor may control the communication module to make a request for the first service to at least one of the first short range communication device and a server which provides the first service.

According to an embodiment of the present invention, the communication module may receive the first service from at least one of the first short range communication device and the server.

According to an embodiment of the present invention, the processor may control transmitting the first service to the scan request device via the communication module.

According to an embodiment of the present invention, a method of an electronic device making a request for a scan via short range communication may include periodically broadcasting an advertisement signal including a scan request for one or more short range communication devices; and receiving a pairing request including a scan result corresponding to the scan request from a scan device in response to the scan request.

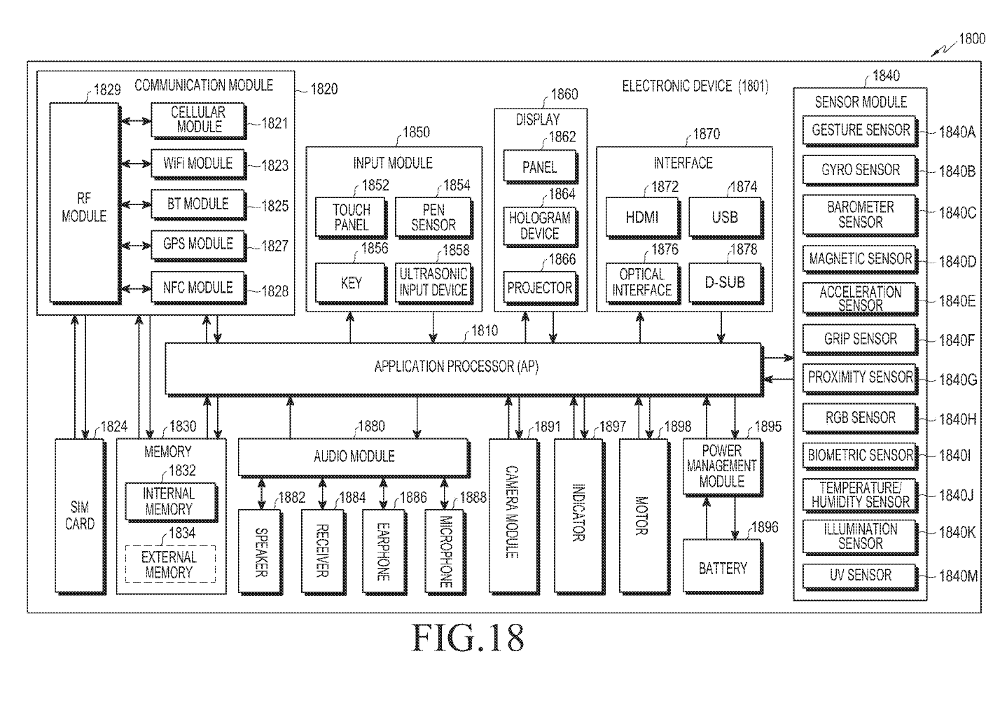

FIG. 18 is a block diagram 1800 of an electronic device 1801 according to an embodiment of the present invention.

Referring to FIG. 18, the electronic device 1801 may include, for example, all or a part of the electronic device 101 illustrated in FIG. 1. For example, the electronic device 101 illustrated in FIG. 1 may include all or some of the electronic device 1801 illustrated in FIG. 18. The electronic device 1801 may include at least one Application Processor (AP) 1810, a communication module 1820, a Subscriber Identification Module (SIM) card 1824, a memory 1830, a sensor module 1840, an input module 1850, a display 1860, an interface 1870, an audio module 1880, a camera module 1891, a power management module 1895, a battery 1896, an indicator 1897, and a motor 1898.

The AP 1810 may control a plurality of hardware or software components connected to the AP 1810 by driving an operating system or an application program and performing processing of various pieces of data and calculations. The AP 1810 may be implemented by, for example, a System on Chip (SoC). According to an embodiment of the present invention, the AP 1810 may further include a Graphics Processing Unit (GPU) and/or an image signal processor. The AP 1810 may load commands or data received from at least one of the other components (for example, a non-volatile memory) in a volatile memory, process the loaded commands or data, and store various pieces of data in the non-volatile memory.

The communication module 1820 may have a component equal or similar to the communication interface 170 of FIG. 1. The communication module 1820 may include, for example, a cellular module 1821, a Wi-Fi module 1823, a BT module 1825, a GPS module 1827, a Near Field Communication (NFC) module 1828, and a Radio Frequency (RF) module 1829.

The cellular module 1821 may provide a voice call, image call, Short Message Service (SMS), or Internet service via, for example, a communication network. According to an embodiment of the present invention, the cellular module 1821 may distinguish between and authenticate electronic devices 1801 within a communication network using the SIM card 1824. According to an embodiment of the present invention, the cellular module 1821 may perform at least some of the functions which can be provided by the AP 1810. According to an embodiment of the present invention, the cellular module 1821 may include a Communication Processor (CP).

Each of the Wi-Fi module 1823, the BT module 1825, the GPS module 1827, and the NFC module 1828 may include, for example, a processor for processing data transmitted/received via the corresponding module. According to any embodiment of the present, at least some (e.g. two or more) of the cellular module 1821, the WiFi module 1823, the BT module 1825, the GPS module 1827, and the NFC module 1828 may be included in one Integrated Circuit (IC) or IC package.

The RF module 1829 may transmit/receive, for example, a communication signal (for example, an RF signal). The RF module 1829 may include, for example, a transceiver, a Power Amplifier Module (PAM), a frequency filter, a Low Noise Amplifier (LNA) or an antenna. According to an embodiment of the present invention, at least one of the cellular module 1821, the WiFi module 1823, the BT module 1825, the GPS module 1827, and the NFC module 1828 may transmit/receive an RF signal via a separate RF module.

The SIM card 1824 may include a card including a subscriber identification module and/or an embedded SIM, and contain unique identification information (for example, an Integrated Circuit Card Identifier (ICCID)) or subscriber information (for example, an International Mobile Subscriber Identity (IMSI)).

The memory 1830 (for example, the memory 130) may include, for example, an internal memory 1832 or an external memory 1834. The internal memory 1832 may include at least one of, for example, a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a flash memory (for example, a NAND flash memory or a NOR flash memory), a hard driver, or a Solid State Drive (SSD).

The external memory 1834 may further include a flash drive, for example, a Compact Flash (CF), a Secure Digital (SD) memory card, a Micro Secure Digital (Micro-SD) memory card, a Mini Secure Digital (Mini-SD) memory card, an extreme Digital (xD) memory card, a memory stick or the like. The external memory 1834 may be functionally and/or physically connected to the electronic device 1801 via various interfaces.

The sensor module 1840 may measure a physical quantity or detect an operation state of the electronic device 1801, and convert the measured or detected information to an electrical signal. The sensor module 1840 may include at least one of, for example, a gesture sensor 1840A, a gyro sensor 1840B, an barometer sensor 1840C, a magnetic sensor 1840D, an acceleration sensor 1840E, a grip sensor 1840F, a proximity sensor 1840G, a color sensor 1840H (for example, a Red/Green/Blue (RGB) sensor), a biometric sensor 1840I, a temperature/humidity sensor 1840J, an illumination sensor 1840K, and an Ultra Violet (UV) light sensor 1840M. Additionally or alternatively, the sensor module 1840 may include an Electronic-nose (E-nose) sensor, an ElectroMyoGraphy (EMG) sensor, an ElectroEncephaloGram (EEG) sensor, an ElectroCardioGram (ECG) sensor, an InfraRed (IR) sensor, an iris sensor, and/or a fingerprint sensor. The sensor module 1840 may further include a control circuit for controlling one or more sensors included therein. In any embodiment of the present invention, the electronic device 1801 may further include a processor configured to control the sensor module 1840 as a part of, or separately from, the AP 1810, and may control the sensor module 1840 while the AP 1810 is in a reduced power consumption or sleep state.

The input module 1850 may include, for example, a touch panel 1852, a (digital) pen sensor 1854, a key 1856, or an ultrasonic input device 1858. The touch panel 1852 may use at least one of, for example, a capacitive type panel, a resistive type panel, an infrared type panel, and an ultrasonic type panel. The touch panel 1852 may further include a control circuit. The touch panel 1852 may further include a tactile layer and provide a tactile reaction to a user.

The (digital) pen sensor 1854 may include, for example, a recognition sheet which is a part of the touch panel 1852 or a separate recognition sheet. The key 1856 may include, for example, a physical button, an optical key or a keypad. The ultrasonic input device 1858 may detect an acoustic wave using a microphone (for example, the microphone 1888) of the electronic device 1801 via an input tool generating an ultrasonic signal to identify data.

The display 1860 (for example, the display 160) may include a panel 1862, a hologram device 1864 or a projector 1866. The panel 1862 may include a component equal or similar to the display 160 of FIG. 1. The panel 1862 of FIG. 18 may be implemented to be, for example, flexible, transparent, or wearable. The panel 1862 may also be configured as one module together with the touch panel 1852. The hologram 1864 displays a stereoscopic image in air by using the interference of light. The projector 1866 may project light onto a screen to display an image. For example, the screen may be located internally or externally to the electronic device 1801. According to an embodiment of the present invention, the display 1860 may further include a control circuit for controlling the panel 1862, the hologram device 1864, or the projector 1866.

The interface 1870 may include, for example, a High-Definition Multimedia Interface (HDMI) 1872, a Universal Serial Bus (USB) 1874, an optical interface 1876, or a D-subminiature (D-sub) connector 1878. The interface 1870 may be included in, for example, the communication interface 170 illustrated in FIG. 1. Additionally or alternatively, the interface 1870 of FIG. 18 may include, for example, a Mobile High-definition Link (MHL) interface, a Secure Digital (SD) card/Multi-Media Card (MMC) interface, or an Infrared Data Association (IrDA) standard interface.

The audio module 1880 may bilaterally convert, for example, a sound and an electrical signal. At least some components of the audio module 1880 may be included in, for example, the input/output interface 140 illustrated in FIG. 1. The audio module 1880 of FIG. 18 processes voice information input or output via, for example, a speaker 1882, a receiver 1884, an earphone 1886, the microphone 1888 or the like.

The camera module 1891 is a device which may photograph a still image and a dynamic image. According to an embodiment of the present invention, the camera module 291 may include one or more image sensors (for example, a front sensor or a back sensor), a lens, an Image Signal Processor (ISP) or a flash (for example, a Light Emitting Diode (LED) or xenon lamp).

The power management module 1895 may manage, for example, power of the electronic device 1801. According to an embodiment of the present invention, the power management module 1895 may include a Power Management Integrated Circuit (PMIC), a charger Integrated Circuit (IC), or a battery gauge. The PMIC may have a wired and/or wireless charging scheme. A magnetic resonance scheme, a magnetic induction scheme, or an electromagnetic scheme may be exemplified as the wireless charging method, and an additional circuit for wireless charging, such as a coil loop circuit, a resonance circuit, a rectifier circuit, and the like may be added. The battery gauge may measure, for example, the remaining amount of battery power, a charging voltage and current, or a temperature. The battery 1896 may include, for example, a rechargeable battery or a solar battery.

The indicator 1897 may show particular statuses of the electronic device 1801 or a part (for example, AP 1810) of the electronic device 1801, for example, a booting status, a message status, a charging status and the like. The motor 1898 may convert an electrical signal into mechanical vibrations, and may generate a vibration or haptic effect. The electronic device 1801 may include a processing unit (for example, a GPU) for supporting mobile TV. The processing unit for supporting mobile TV may process media data according to a standard of Digital Multimedia Broadcasting (DMB), Digital Video Broadcasting (DVB), media flow or the like.

Each of the components of the electronic device 1801 according to the present invention may be implemented by one or more components and the name of the corresponding component may vary depending on a type of the electronic device. The electronic device 101 may include at least one of the above-described component elements, and some component elements may be omitted or an additional component element may be added. Further, some of the components of the electronic device 101 according to an embodiment of the present invention may be combined to form a single entity, and thus, may equivalently execute functions of the corresponding elements prior to the combination.

The term “module” used in the present invention may refer to, for example, a unit including one or more combinations of hardware, software, and firmware. The “module” may be interchangeably used with, for example, the term “unit,” “logic,” “logical block,” “component,” or “circuit.” The “module” may be a minimum unit of an integrated component element or a part thereof. The “module” may be a minimum unit for performing one or more functions or a part thereof. The “module” may be mechanically or electronically implemented. For example, the “module” according to the present invention may include at least one of an Application-Specific Integrated Circuit (ASIC), a Field-Programmable Gate Array (FPGA), and a programmable-logic device for performing operations which are known or will be developed hereinafter.

According to an embodiment of the present invention, at least some of the devices (for example, modules or functions thereof) or the method (for example, operations) according to the present invention may be implemented by a command stored in a non-transitory computer-readable storage medium in a programming module form. When a command is executed by one or more processors (for example, the processor 120), the one or more processors may execute a function corresponding to the command. The non-transitory computer-readable storage medium may be, for example, the memory 130.

The non-transitory computer readable recoding medium may include magnetic media, such as a hard disk, a floppy disk and a magnetic tape, optical media, such as a Compact Disc Read Only Memory (CD-ROM) and a Digital Versatile Disc (DVD), magneto-optical media, such as a floptical disk, and a hardware device configured to store and execute a program instruction (for example, a programming module), such as a Read Only Memory (ROM), a Random Access Memory (RAM), a flash memory, and the like. In addition, the program instructions may include high level language codes, which can be executed in a computer by using an interpreter, as well as machine codes generated by a compiler. The aforementioned hardware device may be configured to operate as one or more software modules in order to perform the operation of the present invention, and vice versa.

The programming module according to the present invention may include one or more of the aforementioned components or may further include other additional components, or some of the aforementioned components may be omitted. Operations executed by a module, a programming module, or other component elements according to various embodiments of the present invention may be executed sequentially, in parallel, repeatedly, or in a heuristic manner. Further, some operations may be executed according to another order or may be omitted, or other operations may be added.

According to an embodiment of the present invention, a storage medium storing commands is provided. When the commands are executed by one or more processors, the one or more processors perform one or more operations. The one or more operations may include periodically broadcasting a scan result for one or more short range communication devices and receiving a scan result of a scan device for the one or more short range communication devices from the scan device in response to the scan request.

Various embodiments disclosed herein are provided merely to easily describe technical details of the present invention and to facilitate understanding of the present invention, and are not intended to limit the scope of the present invention. Therefore, it should be construed that all modifications and changes or modified and changed forms based on the technical idea of the present invention fall within the scope of the present invention, as defined by the appended claims and their equivalents.

What is claimed is:

1. A method of an electronic device for making a request for a scan via short range communication, the method comprising:
periodically broadcasting a scan request for one or more short range communication devices; and
receiving a scan result of a scan device for the one or more short range communication devices from the scan device in response to the scan request.

2. The method of claim 1, wherein the scan request includes a scan condition for the one or more short range communication devices.

3. The method of claim 2, wherein the scan condition includes at least one of short range communication connection information of the electronic device, service identification information requested from the electronic device, and service identification information which the electronic device supports.

4. The method of claim 3, wherein the short range communication connection information includes at least one of information on a short range communication capability of the electronic device and state information of a short range communication module of the electronic device performing the short range communication.

5. The method of claim 2, wherein the scan result includes a short range communication device corresponding to the scan condition.

6. The method of claim 1, further comprising making a request for a short range communication connection using a first short range communication supported by a first short range communication device included in the scan result to the first short range communication device.

7. The method of claim 1, further comprising executing a first application corresponding to a first beacon signal transmitted by a first short range communication device included in the scan result.

8. The method of claim 1, further comprising making a request for a first service corresponding to a first beacon signal included in the scan result to at least one of a first short range communication device transmitting the first beacon signal and a server providing a first service corresponding to the first beacon signal.

9. The method of claim 8, further comprising receiving the first service from at least one of the first short range communication device and the server.

10. The method of claim 1, further comprising making a request for a first service corresponding to a first beacon signal transmitted from a first short range communication device included in the scan result to the scan device.

11. The method of claim 10, further comprising receiving the first service from the scan device.

12. An electronic device for making a request for a scan via short range communication, the electronic device comprising:
a communication module configured to broadcast a scan request for one or more short range communication devices and receive a scan result of a scan device for the one or more short range communication devices from the scan device in response to the scan request; and
a processor configured to control the communication module to periodically broadcast the scan request.

13. The electronic device of claim 12, wherein the scan request includes a scan condition for the one or more short range communication devices.

14. The electronic device of claim 13, wherein the scan condition includes at least one of short range communication connection information of the electronic device, service identification information requested from the electronic device, and service identification information which the electronic device supports.

15. The electronic device of claim 14, wherein the short range communication connection information includes at least one of information on a short range communication capability of the electronic device and state information of a short range communication module of the electronic device performing the short range communication.

16. The electronic device of claim 13, wherein the scan result includes a short range communication device corresponding to the scan condition.

17. The electronic device of claim 12, wherein the processor is further configured to control the communication module to make a request for a short range communication connection using a first short range communication supported by a first short range communication device included in the scan result to the first short range communication device.

18. The electronic device of claim 12, wherein the processor is further configured to control an execution of a first application corresponding to a first beacon signal transmitted by a first short range communication device included in the scan result.

19. The electronic device of claim 12, wherein the processor is further configured to control the communication module to make a request for a first service corresponding to a first beacon signal included in the scan result to at least one of a first short range communication device transmitting the first beacon signal and a server providing a first service corresponding to the first beacon signal.

20. The electronic device of claim 19, wherein the communication module is further configured to receive the first service from at least one of the first short range communication device and the server.

21. The electronic device of claim 12, wherein the processor is further configured to control the communication module to make a request for a first service corresponding to a first beacon signal transmitted from a first short range communication device included in the scan result to the scan device.

22. The electronic device of claim 21, wherein the communication module receives the first service from the scan device.

23. A method of an electronic device for performing a scan via short range communication, the method comprising:
receiving a scan request for one or more short range communication devices periodically broadcast from a scan request device; and
transmitting a scan result for the one or more short range communication devices to the scan request device in response to the scan request.

24. The method of claim 23, wherein the scan request includes a scan condition for the one or more short range communication devices.

25. The method of claim 24, wherein the scan condition includes at least one of short range communication connection information of the scan request device, service identification information requested from the scan request device, and service identification information which the scan request device supports.

26. The method of claim 25, wherein the short range communication connection information includes at least one of information on a short range communication capability of the scan request device and state information of a short range communication module of the scan request device performing the short range communication.

27. The method of claim 25, wherein transmitting the scan result comprises generating the scan result based on the scan condition among results of the scan preformed for the short range communication devices by the electronic device.

28. The method of claim 27, wherein the scan result includes a short range communication device corresponding to the short range communication connection information.

29. The method of claim 27, wherein the scan result includes a short range communication device transmitting a beacon signal corresponding to at least one piece of service identification information requested from the scan request device, wherein the scan request device supports the service identification information.

30. The method of claim 23, further comprising receiving a request for a first service corresponding to a first beacons signal transmitted from a first short range communication device included in the scan result.

31. The method of claim 30, further comprising making a request for the first service to at least one of the first short range communication device and a server which provides the first service based on the request for the first service.

32. The method of claim 31, further comprising receiving the first service from at least one of the first short range communication device and the server.

33. The method of claim 32, further comprising transmitting the first service to the scan request device.

34. An electronic device for performing a scan via short range communication, the electronic device comprising:
a communication module configured to receive a scan request for one or more short range communication devices periodically broadcast from a scan request device and transmit a scan result for the one or more short range communication devices to the scan request device in response to the scan request; and
a processor configured to control the communication module to transmit a scan result for the one or more short range communication devices to the scan request device in response to the scan request.

35. The electronic device of claim 34, wherein the scan request includes a scan condition for the one or more short range communication devices.

36. The electronic device of claim 35, wherein the scan condition includes at least one of short range communication connection information of the scan request device, service identification information requested from the scan request device, and service identification information which by the scan request device supports.

37. The electronic device of claim 36, wherein the short range communication connection information includes at least one of information on a short range communication capability of the scan request device and state information of a short range communication module of the scan request device performing the short range communication.

38. The electronic device of claim 36, wherein the processor is further configured to generate the scan result based on the scan condition among results of the scan preformed for the short range communication devices by the electronic device.

39. The electronic device of claim 38, wherein the scan result includes a short range communication device corresponding to the short range communication connection information.

40. The electronic device of claim 38, wherein the scan result includes a short range communication device transmitting a beacon signal corresponding to at least one piece of service identification information requested from the scan request device, wherein the scan request device supports the service identification information.

41. The electronic device of claim 38, wherein the communication module is further configured to receive a request for a first service corresponding to a first beacon signal transmitted from a first short range communication device included in the scan result.

42. The electronic device of claim 41, wherein the processor is further configured to control the communication module to make a request for the first service to at least one of the first short range communication device and a server which provides the first service.

43. The electronic device of claim 42, wherein the communication module is further configured to receive the first service from a least one of the first short range communication device and the server.

44. The electronic device of claim 43, wherein the processor is further configured to control the communication module to transmit the first service to the scan request device.

45. A method of an electronic device for making a request for a scan via short range communication, the method comprising:
periodically broadcasting an advertisement signal including a scan request for one or more short range communication devices; and
receiving a pairing request including a scan result corresponding to the scan request from a scan device in response to the scan request.
